(19) United States
(12) Patent Application Publication
(10) Pub. No.: US 2019/0375131 A1
(43) Pub. Date: Dec. 12, 2019

(54) INFLATABLE TUBE, METHOD OF MANUFACTURING A CONCRETE MEMBER, AND PIPELINE ARRANGEMENT METHOD APPLYING THE SAME

(71) Applicant: USUN (FOSHAN) TECHNOLOGY CO., LTD., Foshan (CN)

(72) Inventor: CHIU-FONG HUANG, New Taipei City (TW)

(21) Appl. No.: 16/229,346

(22) Filed: Dec. 21, 2018

(30) Foreign Application Priority Data
Jun. 6, 2018 (CN) 201810586602.8

(51) Int. Cl. B28B 7/32; B28B 1/30; B28B 1/14

(52) U.S. Cl. CPC B28B 7/32; B28B 1/14; B28B 1/30

(57) ABSTRACT

An inflatable tube used to form a blind pipe in a channel of a cast concrete member or a blank house to pass water or accommodate a cable is provided. The inflatable tube is a flat hose. The inflatable tube is capable of being wound. The inflatable tube is configured to be arranged in a pre-designed path in the cast concrete member or the blank house, and is capable of being returned to a tubular shape by filling with gas or liquid. A method of manufacturing a concrete member with the blind pipe by applying the inflatable tube is also provided. A pipeline arrangement method to form the blind pipe in a cast concrete member by applying the inflatable tube is also provided.

### FIELD

The subject matter herein generally relates to the building field, and particularly to an inflatable tube for use in manufacturing a concrete member, a method of manufacturing a concrete member, and a pipeline arrangement method applying the same.

### BACKGROUND

During building process, pipeline arrangements may be required, for example, during the production process of manufacturing concrete members (boards, walls, beams, etc.). Traditionally, the processing of concrete members involved the rigid pipes, such as PVC pipes. Arranging these rigid pipes requires cutting, softening, bending, and connection according to the construction. Furthermore, jointing portions and bending portions of the rigid pipes must be sealed before smoothing or pouring concrete.

Therefore, there is room for improvement within the art.

### BRIEF DESCRIPTION OF THE DRAWINGS

Implementations of the present technology will now be described, by way of example only, with reference to the attached figures.

FIG. 1 is an isometric view of an embodiment of an inflatable tube wound around a drum.

FIG. 2 is a schematic view of the inflatable tube in FIG. 1 applied in a mold of a first embodiment.

FIG. 3 is a schematic view of the inflatable tube in FIG. 1 applied in a mold of a second embodiment.

FIG. 4 is a sectional view of the mould in FIG. 3, taken along a line IV-IV.

FIG. 5 is a schematic view of the inflatable tube in FIG. 1 applied in a mold with a steel mesh of a third embodiment.

FIG. 6 is a flow chart of a method of manufacturing a concrete member by applying the inflatable tube in FIG. 1.

FIG. 7 is a flow chart of another method of manufacturing a concrete member by applying the inflatable tube in FIG. 1.

FIG. 8 is a flow chart of a pipeline arrangement method by applying the inflatable tube in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more debytions from a true cylinder. The term “comprising,” when utilized, means “including, but not necessarily limited to”; it specifically indicates open-ended inclusion or membership in the so-described combination, group, series and the like.

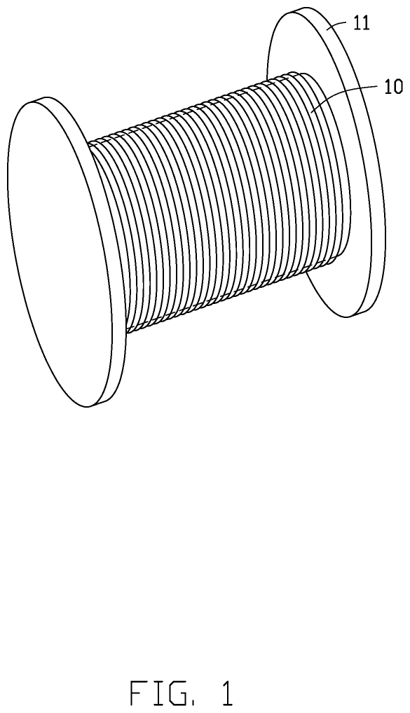

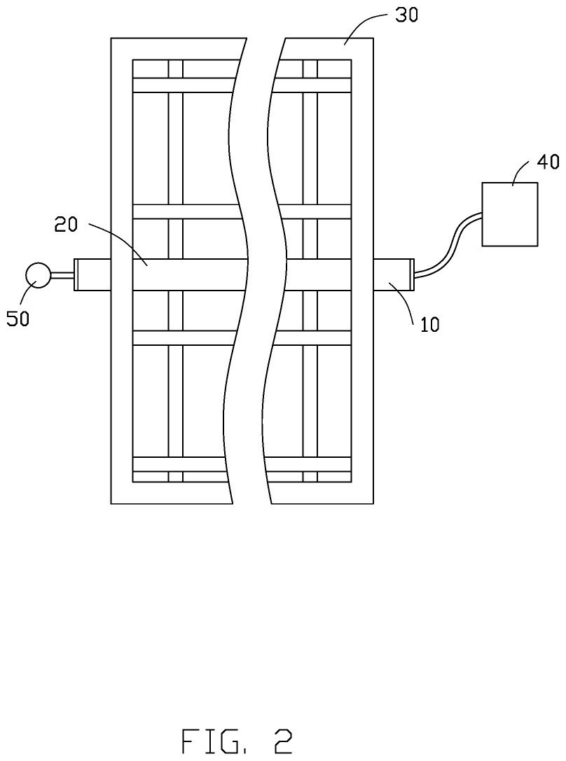

FIG. 1 and FIG. 2 show an inflatable tube 10. The inflatable tube 10 is a flat hose. The inflatable tube 10 is capable of being wound around a drum 11 for convenient transporting. According to actual need, a length of the inflatable tube 10 can be changed by cutting.

The inflatable tube 10 is configured to be arranged in a pre-designed path in a casting of a concrete member or a blank house and then returned to a tubular shape by filling with gas or liquid. The tubular shape may be either circular or elliptical. The inflatable tube 10 is used to form a blind pipe 20 in a channel of the cast concrete member or the blank house to pass water or accommodate a cable. The cast concrete member may be one of the following, but is not limited to, a wall panel, a floor, a staircase, a pillar, a window member, and so on. In other words, the blind pipe 20 is used as a water pipe, a cable pipe, and the like. Material of the inflatable tube 10 should be water-proof and gas-proof, have a high mechanical strength, and high durability. In an embodiment, the inflatable tube 10 is a hose with a fiber braided reinforcing layer. In other embodiments, the inflatable tube 10 may be a hose with a steel wire braided reinforcing layer, have a wire wound reinforcement, or be incorporate composite high-strength materials, such as graphene.

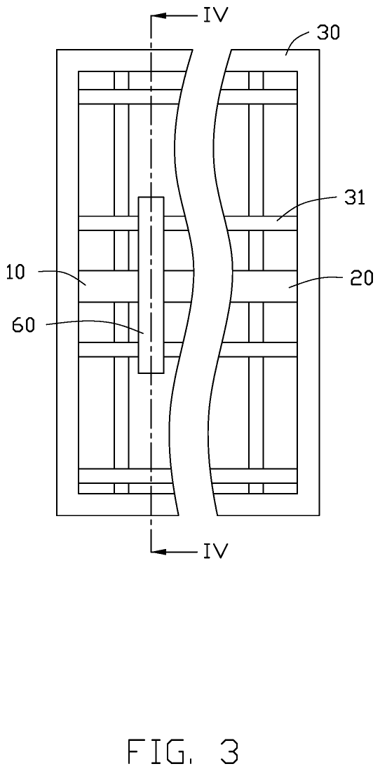

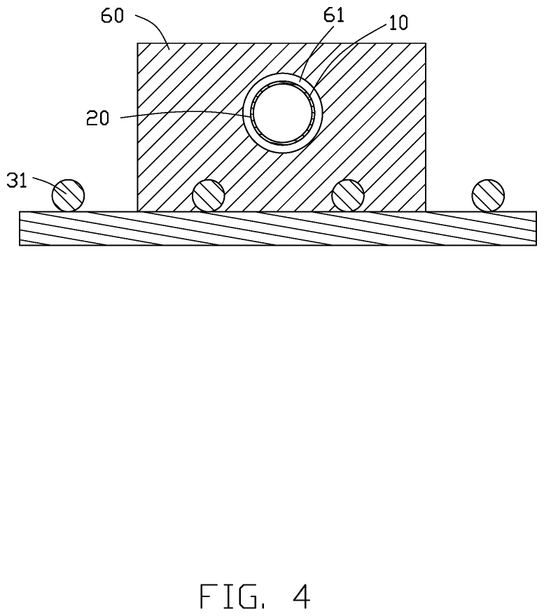

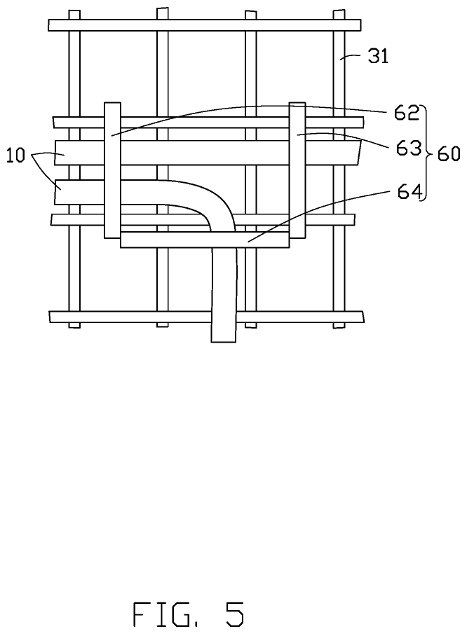

FIGS. 2-5 show how the inflatable tubes 10 are arranged and applied in a mold 30 to create the blind pipes 20. The mold 30 is used to form a cast concrete member. FIG. 2 shows in a first embodiment, FIG. 3 and FIG. 4 show in a second embodiment, and FIG. 5 shows in a third embodiment. The different embodiments are modifications of each other.

Referring to FIG. 2, in the first embodiment, one end of the inflatable tube 10 is blocked, and the other end of the inflatable tube 10 is coupled with an air inflating equipment 40. The air inflating equipment 40 is used to inflate the inflatable tube 10 until the inflatable tube 10 is expanded. Concrete is poured into the mold 30 after the expanded inflatable tube 10 is laid in the mold 30, and the air inflating equipment 40 is taken away after the concrete solidifies. Thus, the inflatable tube 10 creates a blind pipe 20.

Additionally, a pneumatic detector 50 is provided and positioned adjacent to the blocked end of the inflatable tube 10. The pneumatic detector 50 is configured to detect a pressure of air in the inflatable tube 10, and further configured to detect whether the inflatable tube 10 is broken. In other embodiments, the air inflating equipment 40 may be replaced by a device for charging by liquid, and the pneumatic detector 50 may be accordingly replaced by a hydraulic detector.

FIG. 3 and FIG. 4 shows a second embodiment, where a steel mesh 31 is provided into the mold 30 and a positioning member 60 is provided on the steel mesh 31. In the second embodiment, the steel mesh 31 is fixed into the mold 30, and the positioning member 60 is welded onto the steel mesh 31. In other embodiments, the positioning member 60 may be fixed onto the steel mesh 31 using other methods.

A positioning hole 61 is defined on the positioning member 60. A diameter of the positioning hole 61 is larger than a diameter of the blind pipe 20. The positioning hole 61 allows the inflatable tube 10 to pass through, so that the inflatable tube 10 is positioned and guided by the positioning hole 61.

FIG. 5 shows a third embodiment, where there are two inflatable tubes 10 arranged and applied in the mold 30, and there are three positioning members 60 fixed onto the steel mesh 31. The three positioning members 60 are respectively labeled as first member 62, second member 63, and third member 64. The second member 63 is parallel to and spaced from the first member 62, the third member 64 is perpendicular to the first member 62 and is located adjacent to an end of the first member 62. The first member 62 has two positioning holes 61 defined thereon, the second members 63 and the third member 64 each have one positioning hole 61 defined thereon. The positioning holes 61 are similar to or the same with the positioning hole 61 shown in FIG. 4. One of the two inflatable tubes 10 passes through one of the two positioning holes 61 defined on the first member 62 and the positioning hole 61 defined on the second member 63. The other one of the two inflatable tubes 10 passes through the other one of the two positioning holes 61 defined on the first member 62 and then bends to pass through the positioning hole 61 defined on the third member 64.

In other embodiments, a path of the inflatable tubes 10, a number of positioning members 60, positions of the positioning member 60 fixed on the steel mesh 31, and a number of the positioning holes 61 may be varied as needed.

In other embodiments, the structure of the positioning member 60 may be otherwise, as long as it can position the inflatable tube 10. In other embodiments, the positioning member 60 may also be omitted, as long as the inflatable tube 10 can be positioned in the channel of the cast concrete member or the blank house.

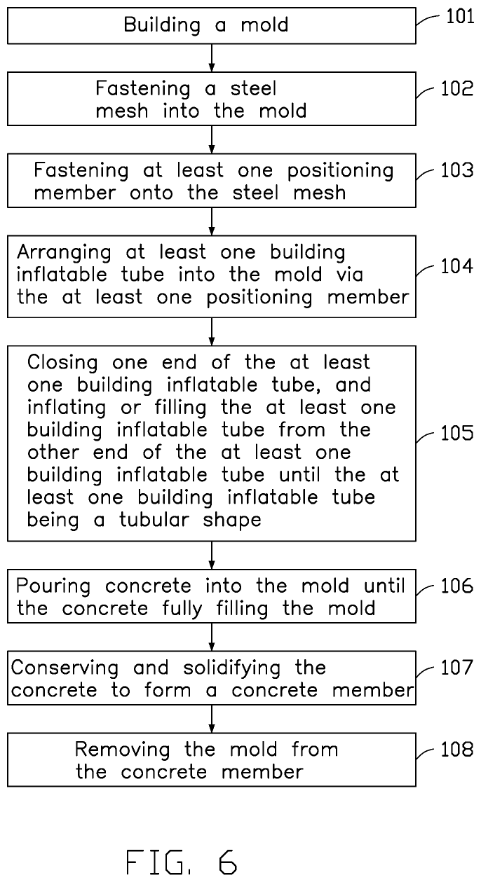

FIG. 6 shows a method of manufacturing a concrete member 100 with the upper blind pipe 20 by applying the upper inflatable tube 10 is presented. The method 100 is provided by way of example, as there are a variety of ways to carry out the method. Each block shown in FIG. 6 represents one or more processes, methods, or subroutines, carried out in the exemplary method. Furthermore, the illustrated order of blocks is illustrative only and the order of the blocks can change. Additional blocks can be added or fewer blocks may be utilized, without departing from this disclosure. The exemplary method 100 can begin at block 101.

At block 101, a mold 30 is built. The mold 30 is used to form the concrete member. The mold 30 may include several sections joined together by several boards to meet actual needs.

At block 102, a steel mesh 31 is fastened into the mold 30. A length and a width of the steel mesh 31 are designed according to that of the mold 30 and actual needs. In an embodiment, the steel mesh 31 is bound into the mold 30.

At block 103, at least one positioning member 60 is fastened onto the steel mesh 31. A position of the at least one positioning member 60 is designed according to actual needs. The positioning member 60 may be fastened using binding or welding.

At block 104, at least one inflatable tube 10 is arranged into the mold 30 by the at least one positioning member 60. A length of the at least one inflatable tube 10 is changed by cutting according to actual needs. At least one positioning hole 61 is defined on the at least one positioning member 60. The at least one inflatable tube 10 passes through the at least one positioning hole 61 of the positioning member 60.

At block 105, one end of the at least one inflatable tube 10 is closed, and the at least one inflatable tube 10 is inflated or filled from the other end of the at least one inflatable tube 10 until the at least one inflatable tube 10 being a tubular shape. Specifically, an air inflating equipment 40 or a charging device is provided to inflate or fill the inflatable tube 10. In an embodiment, the air inflating equipment 40 is provided to inflate the inflatable tube 10 until the inflatable tube 10 being the tubular shape. Furthermore, a pneumatic detector 50 is provided and positions adjacent to the blocked end of the inflatable tube 10 to detect a pressure of air in the inflatable tube 10. In other embodiments, when the air inflating equipment 40 is replaced by the charging device for filling liquid, the pneumatic detector 50 may be accordingly replaced by a hydraulic detector to detect a pressure of the liquid in the inflatable tube 10.

At block 106, concrete is poured into the mold 30 until the concrete fully filling the mold 30. The concrete is poured into the mold 30 accompanying with constantly oscillating and stirring, so that the concrete fully filling the mold 30.

At block 107, the concrete is conserved and solidified to form a concrete member. In an embodiment, the concrete and the mold 30 are protected in a constant temperature room and accompany with daily watering maintenance.

At block 108, the mold 30 is removed from the concrete member.

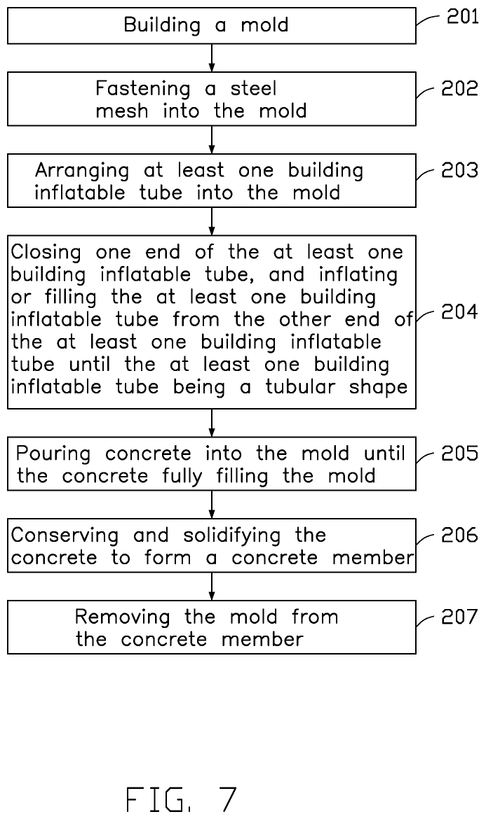

Referring to FIG. 7, another method of manufacturing a concrete member 200 is presented. The method 200 is modified upon the method 100 with fewer blocks. Specifically, the block 103 of the method 100 is omitted in the method 200, and the inflatable tube 10 is directly arranged into the mold 30 without the positioning member 60. The exemplary method 200 can begin at block 201.

At block 201, a mold 30 is built. The mold 30 assists in forming the concrete member. The mold 30 may include several sections joined together by several boards to meet actual needs.

At block 202, a steel mesh 31 is fastened into the mold 30. A length and a width of the steel mesh 31 are designed according to that of the mold 30 and actual needs. In an embodiment, the steel mesh 31 is bound into the mold 30.

At block 203, at least one inflatable tube 10 is arranged into the mold 30. A length of the at least one inflatable tube 10 is changed by cutting according to actual needs.

At block 204, one end of the at least one inflatable tube 10 is closed, and the at least one inflatable tube 10 is inflated or filled from the other end of the at least one inflatable tube 10 until the at least one inflatable tube 10 being the tubular shape. Specifically, an air inflating equipment 40 or a charging device is provided to inflate or fill the inflatable tube 10. In an embodiment, the air inflating equipment 40 is provided to inflate the inflatable tube 10 until the inflatable tube 10 being the tubular shape. Furthermore, a pneumatic detector 50 is provided and positions adjacent to the blocked end of the inflatable tube 10 to detect an air pressure of air in the inflatable tube 10. In other embodiments, when the air inflating equipment 40 is replaced by the charging device for filling liquid, the pneumatic detector 50 may be accordingly replaced by a hydraulic detector to detect a pressure of the liquid in the inflatable tube 10.

At block 205, concrete is poured into the mold 30 until the concrete fully filling the mold 30. The concrete is poured into the mold 30 accompanying with constantly oscillating and stirring, so that the concrete fully filling the mold 30.

At block 206, the concrete is conserved and solidified to form a concrete member. In an embodiment, the concrete and the mold 30 are protected in a constant temperature room and accompany with daily watering maintenance.

At block 207, the mold 30 is removed from the concrete member.

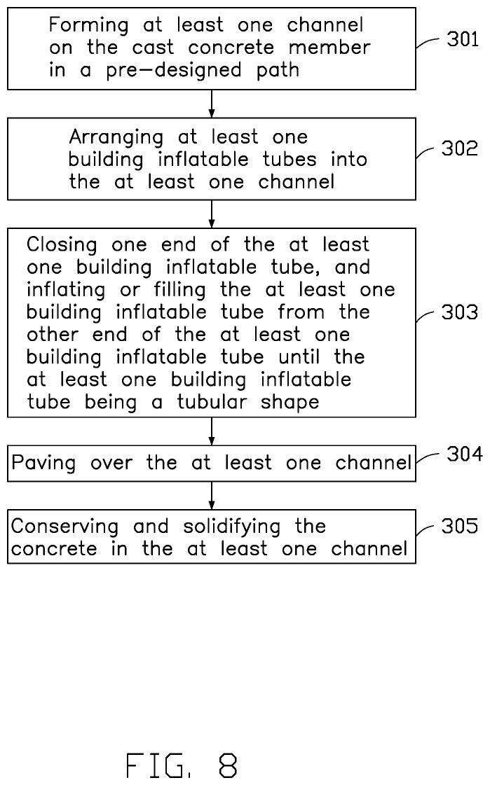

Referring to FIG. 8, a pipeline arrangement method 300 is presented. The pipeline arrangement method 300 is used to form the upper blind pipe 20 in a cast concrete member by applying the upper inflatable tubes 10. The pipeline arrangement method 300 is provided by way of example, as there are a variety of ways to carry out the method. Each block shown in FIG. 8 represents one or more processes, methods, or subroutines, carried out in the exemplary method. Furthermore, the illustrated order of blocks is illustrative only and the order of the blocks can change. Additional blocks can be added or fewer blocks may be utilized, without departing from this disclosure. The exemplary method 300 can begin at block 301.

At block 301, at least one channel is formed on the cast concrete member in a pre-designed path. The at least one channel is en-grooved on at least one outside surface of the cast concrete member.

At block 302, at least one inflatable tube 10 is arranged into the at least one channel. Specifically, a length of the inflatable tube 10 is changed by cutting to meet corresponding channels. Furthermore, at least one position member 60 may be fastened into the channels to assist arranging the inflatable tubes 10.

At block 303, one end of the at least one inflatable tube 10 is closed, and the at least one inflatable tube 10 is inflated or filled from the other end of the at least one inflatable tube 10 until the at least one inflatable tube 10 being a tubular shape. Specifically, an air inflating equipment 40 or a charging device is provided to inflate or fill the inflatable tube 10. In an embodiment, the air inflating equipment 40 is provided to inflate the inflatable tube 10 until the inflatable tube 10 being the tubular shape. Furthermore, a pneumatic detector 50 is provided to detect an air pressure of air in the inflatable tube 10. In other embodiments, when the air inflating equipment 40 is replaced by the charging device for filling liquid, the pneumatic detector 50 may be accordingly replaced by a hydraulic detector to detect a pressure of the liquid in the inflatable tube 10.

At block 304, the at least one channel is paved over. Specifically, concrete are poured into the channels until the concrete fully fill the channels, and then the concrete is flatten.

At block 305, the concrete is conserved and solidified in the at least one channel. In an embodiment, the concrete in the channels are conserved with daily watering maintenance.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An inflatable tube, used to form a blind pipe in a channel of a cast concrete member or a blank house to pass water or accommodate a cable, wherein the inflatable tube is a flat hose and capable to be wound, the inflatable tube is configured to be arranged in a pre-designed path in the cast concrete member or the blank house, and is capable of being returned to a tubular shape by filling with gas or liquid.

2. The inflatable tube of claim 1, wherein the inflatable tube is a hose with a fiber braided reinforcing layer.

3. The inflatable tube of claim 1, wherein the inflatable tube is a hose with a steel wire braided reinforcing layer.

4. The inflatable tube of claim 1, wherein the inflatable tube is a hose having a wire wound reinforcement.

5. The inflatable tube of claim 1, wherein the inflatable tube is a hose incorporating with composite high-strength materials.

6. A manufacturing method of a concrete member, comprising:
building a mold;
fastening a steel mesh into the mold;
arranging at least one inflatable tube into the mold; wherein the at least one inflatable tube is a flat hose and capable to be wound, the inflatable tube is capable of being returned to a tubular shape by filling with gas or liquid;
closing one end of the at least one inflatable tube, and inflating or filling the at least one inflatable tube from the other end of the at least one inflatable tube until the at least one inflatable tube being the tubular shape;
pouring concrete into the mold until the concrete fully filling the mold;
conserving and solidifying the concrete to form the concrete member; and
removing the mold from the concrete member.

7. The method of manufacturing the concrete member of claim 6, wherein the steel mesh is bound into the mold.

8. The method of manufacturing the concrete member of claim 6, wherein at least one positioning member is provided before arranging the at least one inflatable tube, the at least one positioning member is fastened onto the steel mesh, the at least one inflatable tube is arranged into the mold by the at least one positioning member.

9. The method of manufacturing the concrete member of claim 8, wherein the positioning member is bound or weld onto the steel mesh.

10. The method of manufacturing the concrete member of claim 8, wherein at least one positioning hole is defined on the at least one positioning member, the at least one inflatable tube passes through the at least one positioning hole of the positioning member.

11. The method of manufacturing the concrete member of claim 6, wherein an air inflating equipment is provided to inflate the inflatable tube until the inflatable tube being the tubular shape, a pneumatic detector is provided and positions adjacent to a blocked end of the inflatable tube to detect a pressure of air in the inflatable tube.

12. The method of manufacturing the concrete member of claim 6, wherein a charging device is provided to fill liquid into the inflatable tube until the inflatable tube being the tubular shape, a hydraulic detector is provided to detect a pressure of the liquid in the inflatable tube.

13. The method of manufacturing the concrete member of claim 6, wherein the concrete is poured into the mold accompanying with constantly oscillating and stirring.

14. The method of manufacturing the concrete member of claim 6, wherein before removing the mold, the concrete and the mold are protected in a constant temperature room and accompany with daily watering maintenance.

15. A pipeline arrangement method, comprising:
forming at least one channel on a cast concrete member in a pre-designed path;
arranging at least one inflatable tubes into the at least one channel, wherein the at least one inflatable tube is a flat hose and capable to be wound, the at least one inflatable tube is capable of being returned to a tubular shape by filling with gas or liquid;
closing one end of the at least one inflatable tube, and inflating or filling the at least one inflatable tube from the other end of the at least one inflatable tube until the at least one inflatable tube being the tubular shape;
paving over the at least one channel; and
conserving and solidifying the concrete in the at least one channel.

16. The pipeline arrangement method of claim 15, wherein the at least one channel is en-grooved on at least one outside surface of the cast concrete member.

17. The pipeline arrangement method of claim 15, wherein at least one positioning member is provided before arranging the at least one inflatable tubes, the at least one positioning member is fastened into the at least one channel, the at least one inflatable tubes are arranged into the at least one channel by the at least one positioning member.

18. The pipeline arrangement method of claim 15, wherein an air inflating equipment is provided to inflate the at least one inflatable tube until the at least one inflatable tube being the tubular shape, a pneumatic detector is provided to detect a pressure of air in the at least one inflatable tubes.

19. The pipeline arrangement method of claim 15, wherein a charging device is provided to fill liquid into the at least one inflatable tube until the at least one inflatable tube being the tubular shape, a hydraulic detector is provided to detect a pressure of the liquid in the at least one inflatable tube.
